(19) United States
(12) Patent Application Publication
(10) Pub. No.: US 2002/0077923 A1
(43) Pub. Date: Jun. 20, 2002

(54) Method and apparatus for performing on-line product registration

(76) Inventors: Brian M. Siegel, Washingtonville, NY (US); Gregory D. Gudorf, San Diego, CA (US)

Correspondence Address: Stuart H. Mayer, Esq., Mayer, Fortkort & Williams, L.L.C., Suite 250, 200 Executive Drive, West Orange, NJ, 07052, US

(21) Appl. No.: 09/741,760

(22) Filed: Dec. 20, 2000

(51) Int. Cl. G06F 17/60

(52) U.S. Cl. 705/26

(57) ABSTRACT

A method and apparatus is provided for performing on-line registration over an open computer network (e.g., the Internet) of an item previously purchased by a customer. The method begins by receiving over the open computer network a request from the customer to register the purchased item. Next, a registration form is provided over the open computer network, which is to be completed by the customer. The registration form requests customer information such as an identifier identifying the purchased item. Upon receiving a completed registration form from the customer, a database is searched to generate a list of purchasable items. The selection of the list of purchasable items is based at least in part on the identifier that identifies the purchased item. Finally, the customer is provided with the list of purchasable items and an opportunity to purchase any one or more of the purchasable items.

### FIELD OF THE INVENTION

The present invention relates generally to a method and apparatus by which a customer registers over the Internet a previously purchased product, and more specifically to a method and apparatus for offering to sell the customer additional products during the registration process.

### BACKGROUND OF THE INVENTION

The flow of goods and services in a successful market economy depends in part on the ability of customers to learn what goods and services are available and the ability of merchants to learn what goods and services are desired by customers. For example, many different ways are available for consumers to obtain information about goods and services. Traditional avenues include visiting stores, browsing catalogs, viewing advertisements on television, newspapers and the like, and, more recently, searching the Internet. Likewise, merchants try to collect information about consumer's desires and buying habits so that they can better serve their current customers and gain new ones, thereby enhancing profits. Some ways merchants use to collect this information includes maintaining files of current customer purchase data, obtaining mailing lists from other vendors, and test marketing.

From a consumer perspective, traditional methods of advertising are often problematic. It is very difficult for consumers to select items of interest from the daily bombardment of advertising, which include television and radio ads, billboards, newspaper and magazine advertisements and inserts, posters and the like. Moreover, because advertising is ephemeral, it is unlikely to be available when the customer will be most interested and receptive to it. To identify and locate a particular item of interest may require many phone calls, visits to stores and extensive searching on the Internet.

From the merchant's perspective, traditional methods of advertising are also problematic. In particular, it is very expensive to target advertisements to specific customers. One approach is to advertise in specialized publications or on specialized web sites that should appeal to very specific consumers. Another approach is to advertise on a web site that is somehow related to the content of the web page. For example, a web page of a real estate company might include advertising banners containing advertisements for mortgage companies. Even in these cases it remains difficult to determine the particular needs and interests of a given consumer. Furthermore, it is also difficult to reach those consumers who are currently interested in a given item and who might be predisposed to make a purchase. Merchants need a mechanism for delivering information when it would be most useful to a receptive consumer. That is, the merchant ideally needs to know both what a customer wishes to purchase and when he wants to purchase it.

### SUMMARY OF THE INVENTION

The present inventor has realized that at about the time of making an initial purchase, a customer is often inclined to additionally purchase product upgrades or enhancements, or additional products that can enhance the use and enjoyment of the initially purchased product. Presumably, this may be because the consumer's attention is often most focused on the purchased product at the time of the purchase.

The present invention provides a method of performing on-line registration over an open computer network of an item previously purchased by a customer. The method begins by receiving over the open computer network a request from the customer to register the purchased item. Next, a registration form is provided over the open computer network, which is to be completed by the customer. The registration form requests customer information such as an identifier identifying the purchased item. Upon receiving a completed registration form from the customer, a database is searched to generate a list of purchasable items. The selection of the list of purchasable items is based at least in part on the identifier that identifies the purchased item. Finally, the customer is provided with the list of purchasable items and an opportunity to purchase any one or more of the purchasable items.

In accordance with one aspect of the invention, the computer network is the Internet.

In accordance with another aspect of the invention, customer information requested on the registration form further includes a customer name, physical address, electronic mail address and a phone number. The customer information requested on the registration form may further include a list of one or more items in possession of the customer having functionality associated with the purchased item.

In accordance with yet another aspect of the invention, the registration form includes a pull-down menu that includes a list of one or more items having functionality associated with the purchased item.

In accordance with another aspect of the invention, the purchasable items include an upgrade or enhancement to the purchased item. The purchasable items may also include items that are usable in conjunction with the purchased item.

In accordance with another aspect of the invention, upon selection of a selectable icon by the customer, a visual representation is provided of the selected purchasable item corresponding to the selected icon. In some cases the visual representation of the selected purchasable item may include a diagram depicting the interoperability between the purchased item and the selected purchasable item.

### BRIEF DESCRIPTION OF THE DRAWINGS

FIG. 1 shows the overall system architecture for practicing the present invention.

FIG. 2 shows a block diagram of the central controller depicted in FIG. 1.

FIG. 3 shows an illustrative customer interface device that may be employed in connection with the present invention.

FIG. 4 is an architectural block diagram of the customer interface device illustrated in FIG. 2.

FIG. 5 is a flowchart depicting how a customer registers a previously purchased product and purchases additional products.

FIG. 6 shows an illustrative electronic product registration form that may be displayed as a web page on the customer interface device.

FIG. 7 shows an example of a web page displaying a wiring diagram that includes a visual representation of the previously purchased product and any additional products identified by the customer on the product registration form.

FIG. 8 shows the web page of FIG. 7 with a visual representation of a product that has been selected by the customer for prospective purchase.

### DETAILED DESCRIPTION

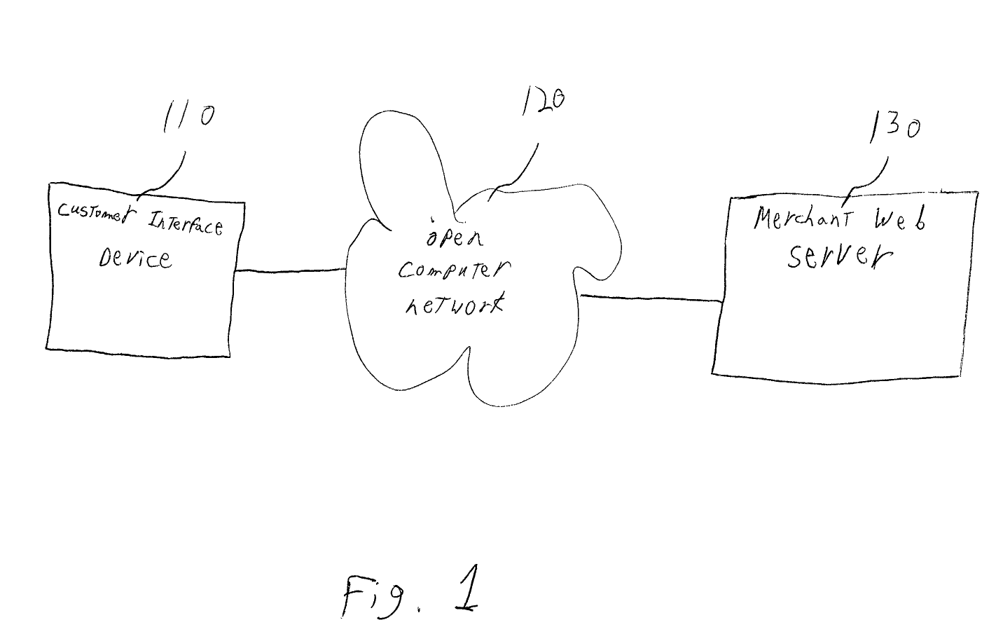

The system architecture of one embodiment of the apparatus and method of the present invention is illustrated with reference to FIG. 1. The system includes a customer interface device and a Merchant web server that are in communication with one another over an open network 120. Open network 120 is a collection of individual networks that are linked together by a set of standard protocols. One example of an open network is the Internet, which employs standard protocols such as TCP/IP and HTTP. Merchant web server 130 is a computer system that provides over the Internet user-viewable hypertext documents (commonly referred to a web document or web page) which are interlinked with one another. Currently, the primary protocol for allowing applications to locate and acquire web documents is HTTP, and the web pages are encoded using HTML. However, as used herein, the terms “web” and “web site” are intended to encompass markup languages and transport protocols which may be used in place of, or in addition to, HTML and HTTP.

Merchant web server 130 provides a web site having various functionality which allows customers to electronically register products they have purchased. Merchant web server 130 may be operated by the manufacturer, distributor, retailer, or the like, of the purchased product. Alternatively, merchant web server 130 may be operated by an associate affiliated with one or more of these business entities. Merchant web server 130 may also provide additional functionality allowing customers to obtain product information and purchase products. In the case of the latter the web site operator handles the various order processing, shipping, collections, and customer service tasks associated with the sale of goods.

By accessing merchant web server 130, the customer can register products he or she has purchased to activate warranties and provide traditional product registration information such as product updates, recalls, and promotions, for example. In accordance with the present invention, the registration process provides an opportunity for the merchant to offer to sell the customer additional products that may enhance his or her use and enjoyment of the purchased product being registered. For example, if the purchased product is a personal computer, the merchant may offer the customer various accessories such as a backup drive or modem, for example. Moreover, the registration process may be used to elicit information from the customer that allows the merchant to more precisely offer the customer particular products or services that best suit his or her needs. Returning to the example of the personal computer, during the registration process the merchant may prompt the customer to identify any additional equipment they own which is associated with the computer such as a game board. If the merchant determines that the customer does not have an appropriate user interface such as a joystick, for example, the merchant may immediately offer the customer a selection of different joysticks.

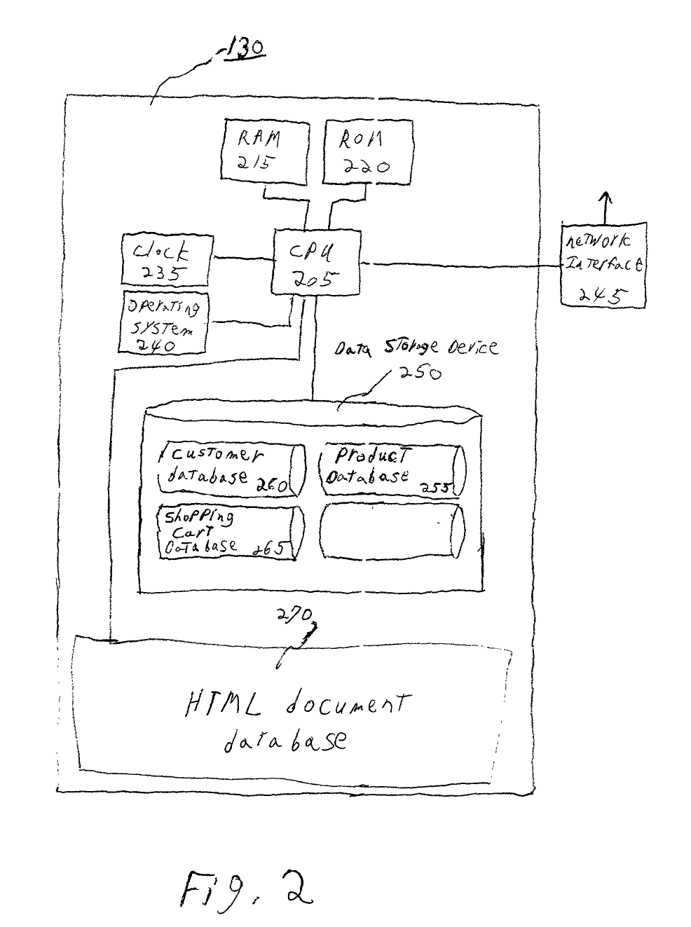

As shown in FIG. 2, merchant web server 130 includes central processor (CPU) 205, RAM 215, ROM 220, clock 235, operating system 240, network interface 245, and data storage device 250. Web server 130 may be a conventional personal computer or computer workstation with sufficient memory and processing capability. Web server 130 200 must be capable of high volume transaction processing, performing a significant number of mathematical calculations in processing communications and database searches. Illustrative processors that may be employed include a Pentium microprocessor, commonly manufactured by Intel Inc., a PowerPC available from Motorola, or an UltraSPARC processor available from Sun Microsystems.

Data storage device 250 may include hard disk magnetic or optical storage units, as well as CD-ROM drives or flash memory. Data storage device 250 contains databases used in the processing of transactions in the present invention, including customer database 260, product database 255, shopping cart database 265, and HTML document database 270. In one embodiment of the invention database software, such as available from Oracle Corporation, is used to create and manage these databases.

Network interface 245 is the gateway to communicate with customers through their respective interface devices 110. Conventional internal or external modems may serve as network interface 245. Network interface 245 supports modems at a range of baud rates from 1200 upward, but may combine such inputs into a T1 or T3 line if more bandwidth is required. In one embodiment of the invention, network interface 245 is connected with the Internet and/or any of the commercial online services such as America Online, CompuServe, or Prodigy, allowing members access to the service from a wide range of online connections. Several commercial email servers include the above functionality. Users can exchange messages with enclosures such as files, graphics, video and audio.

While the above embodiment describes a single computer acting as the merchant web server 130, those skilled in the art will realize that the functionality can be distributed over a plurality of computers. In another embodiment, web server 130 may be configured in a distributed architecture, wherein the databases and processors are housed in separate units or locations.

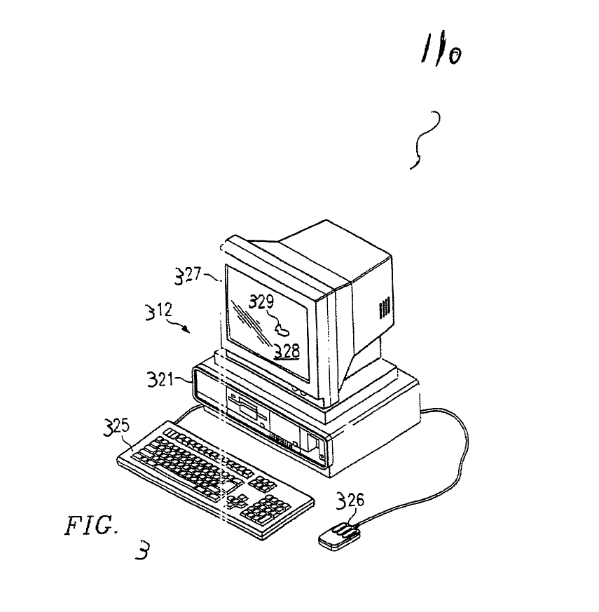

FIG. 3 shows a block diagram of an illustrative customer interface device 300 that may be employed in connection with the present invention. While the device 300 is illustrated as a general purpose computer, those or ordinary skill in the art will recognize that the user interface device may be any device that can communicate with, and download information from, an open computer network such as the Internet. The device 300 includes a system unit 321, a keyboard 325, a mouse 326 and a display unit 327. The screen 328 of the display unit 327 is used to present a graphical user interface (GUI). The graphical user interface supported by the operating system of the device 300 allows the user to use a point and shoot method of input, i.e., by moving the mouse pointer 329 to an icon representing a data object at a particular location on the screen 328 and pressing on the mouse buttons to perform a user command or selection. This type of arrangement also allows the user to directly manipulate an icon from one position to another on the screen, all in a known manner.

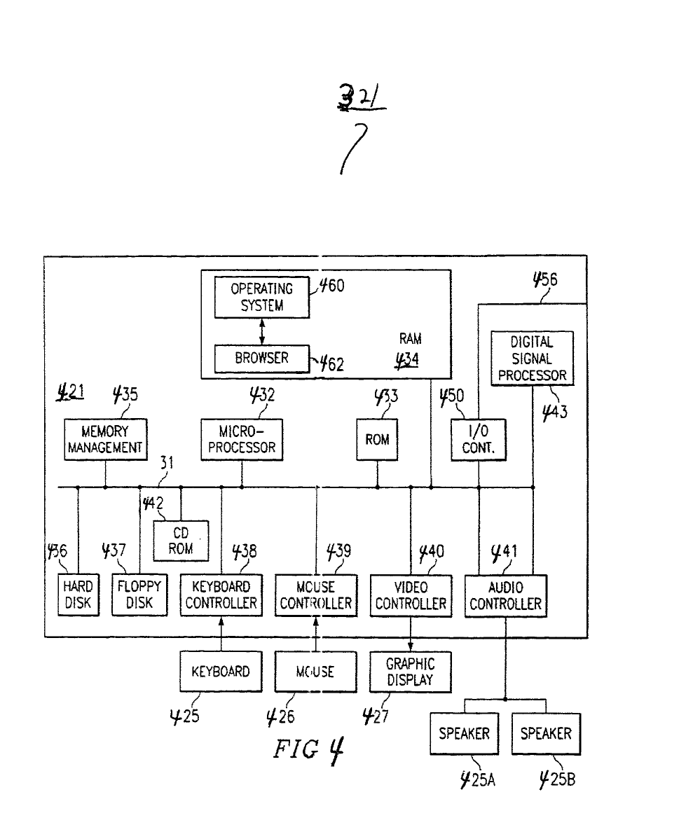

Turning to FIG. 4, the system unit 321 includes a system bus or plurality of system buses 431 to which various components are coupled and by which communication between the various components is accomplished. The microprocessor 432 is connected to the system bus 431 and is supported by read only memory (ROM) 433 and random access memory (RAM) 434 also connected to system bus 431. The ROM 433 contains among other code the Basic Input-Output system (BIOS), which controls basic hardware operations such as the interaction of the disk drives and the keyboard. The RAM 434 is the main memory into which the operating system and application programs are loaded. The memory management chip 435 is connected to the system bus 431 and controls direct memory access operations including, passing data between the RAM 434 and hard disk drive 436 and floppy disk drive 437. The CD ROM 442, also coupled to the system bus 431, is used to store a large amount of data, e.g., a multimedia program or large database. Also connected to this system bus 431 are various I/O controllers: the keyboard controller 438, the mouse controller 439, the video controller 440, and the audio controller 441. The keyboard controller 438 provides the hardware interface for the keyboard 25, the controller 439 provides the hardware interface for the mouse (or other point and click device) 426, the video controller 440 is the hardware interface for the display 427, and the audio controller 441 is the hardware interface for the multimedia speakers 425a and 425b. A network interface card (NIC) interfaces to the I/O controller 450 to enable communication via path 456 to other computers over the computer network.

The operating system 460 of the computer may be MS-DOS, WINDOWS 3.x, WINDOWS 95, WINDOWS NT, OS/2, AIX, or any other known and available operating system. RAM 434 also supports a number of Internet access tools including, for example, an HTTP-compliant web browser 462. Known browser software includes Netscape Navigator, Microsoft Internet Explorer, mosaic, and the like. RAM 434 may also support other Internet services including simple mail transfer protocol (SMTP) or e-mail, file transfer protocol (FTP), network news transfer protocol (NNTP) or “Usenet”, and remote terminal access (Telnet).

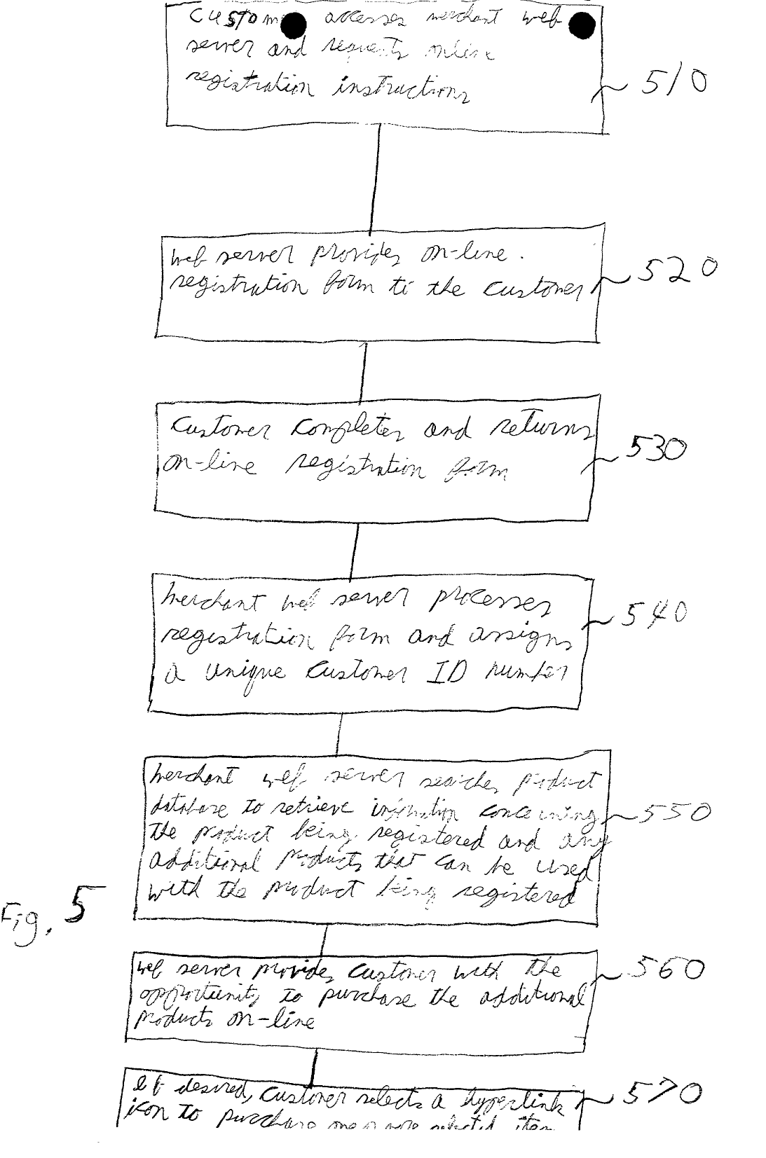

FIG. 5 shows an exemplary process by which a customer registers a purchased product on the merchant's web site. The registration process begins at step 510 by selecting the proper hyperlink containing online registration instructions. The central processor 205 accesses the local database of HTML documents and, at step 520, returns an online registration application document to the customer's web browser. The customer can then fill out the detailed online registration form 600.

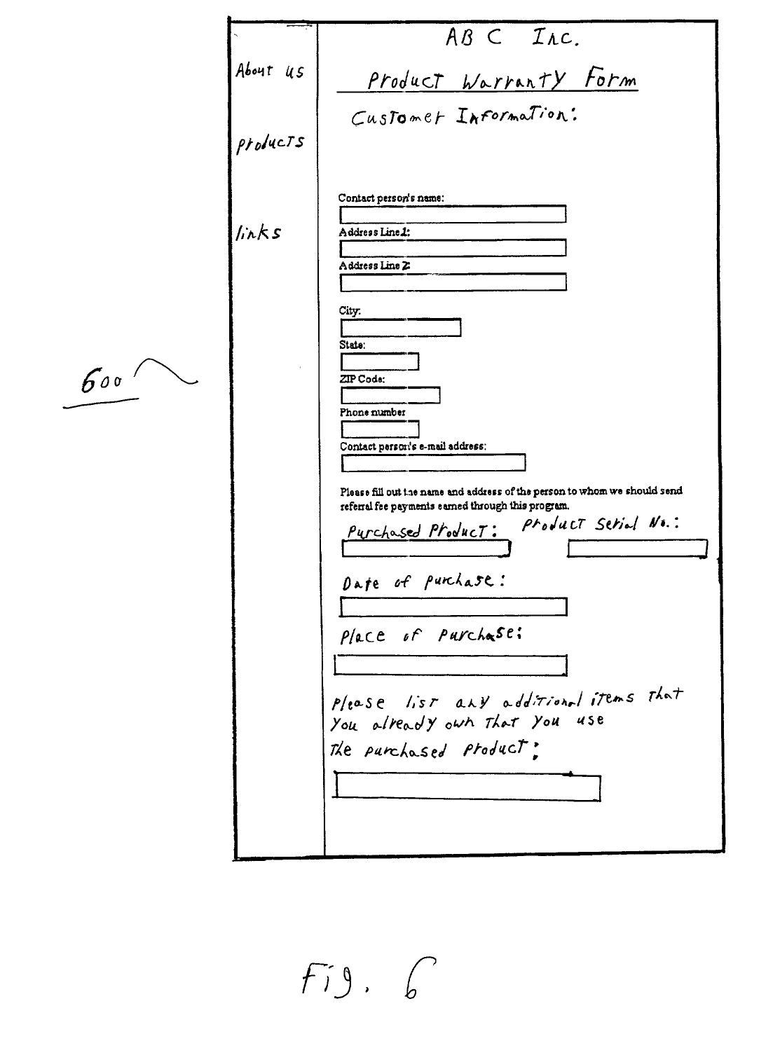

FIG. 6 shows an illustrative embodiment of the online registration form 600. The registration form requests information about the customer such as his or her name, physical and email address, phone number, the purchased product to be registered (as identified, for example, by an SKU number derived from a universal product code, a serial number or other manufacturer code, or the like) and the retailer from whom the product was purchased (assuming that the merchant is not the retailer). In addition, the customer is provided space to identify other products they own which are associated with the product being registered. The customer may simply type the items in the available window. Alternatively, or in addition thereto, the customer may be offered the option of selecting items from a pull-down menu that is pre-populated based on the purchased product. It should be noted that FIG. 6 is merely illustrative of the many registration formats that may be employed and only representative of the many types of information that may be requested.

Referring again to FIG. 5, once the electronic registration form is completed by the customer at step 530, it is sent from the customer's interface device 110 to the merchant web site 130 for further processing. In response to the submission of the enrollment form, the central processor 205 processes the information contained on the registration form at step 540. In one embodiment of the invention, an agent is used to scan the form for pre-specified terms and if such a term is found, to flag the application for further review either electronically or manually by a staff member. If no such term is found and the application is complete, the central processor 205 accepts the registration form.

Once the registration form has been completed the central processor 205 generates a unique customer ID to be assigned to the customer, also at step 540. In addition, the central processor 205 creates a database entry corresponding to the customer and stores the customer ID and the information provided by the customer on the registration form as a unique entry in the customer database 260. Database 260 may be any type of data repository including, for example, an SQL table or ASCII text file. This database entry allows the merchant web server 130 to properly track the customer's interests and purchases, as further described below.

Based on the information provided by the customer on the registration form, central processor 205 searches product database 255 at step 550. Product database 255 includes product information such as the features and specifications of the various products available from the merchant. Upon retrieving the product information for the product being registered, the central processor 205 determines if any upgrades or product enhancements (e.g., product enhancements) are available for it. If so, they are sent to the customer's interface device 110 at step 560 so that the customer can determine if he or she is interested in them. If the customer is indeed interested in the upgrade or product enhancement, it may be purchased directly from the merchant's web site at step 570 in the manner described below.

In addition to product upgrades or enhancements, the customer may also be offered additional products that can be used in conjunction with the product being registered. The additional products to be offered are selected based on the products the customer has identified as owning and being associated with the product being registered. Once again, the customer may purchase the additional products directly from the merchant's web site in the manner described below.

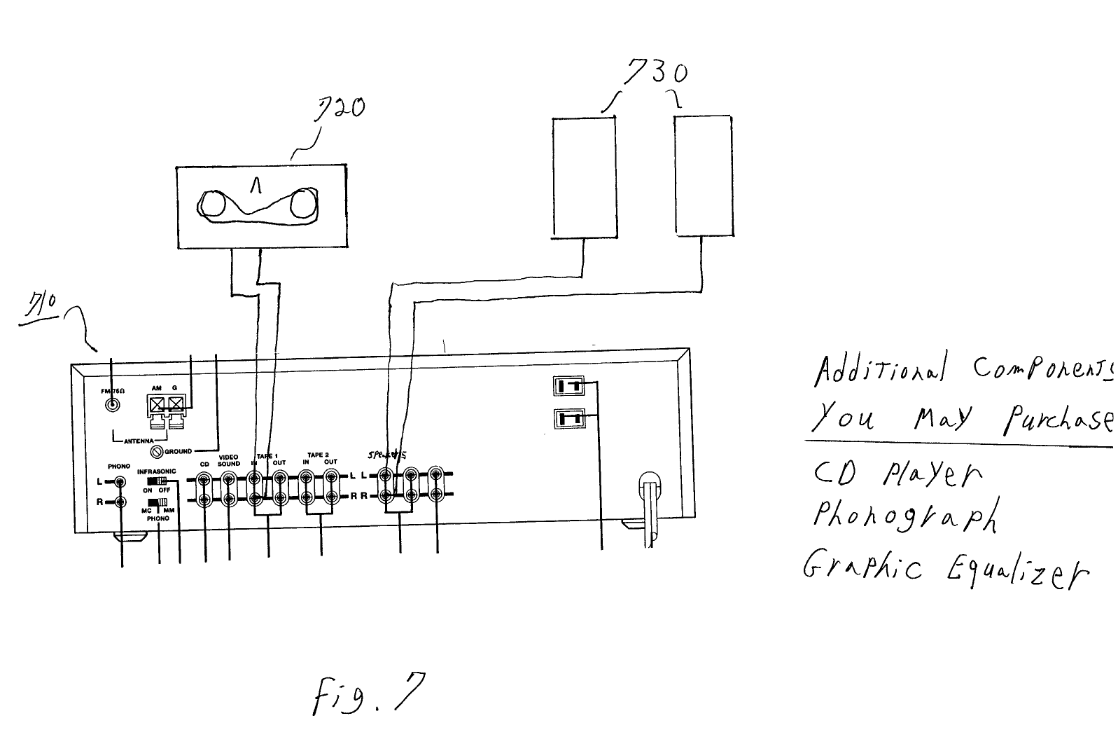

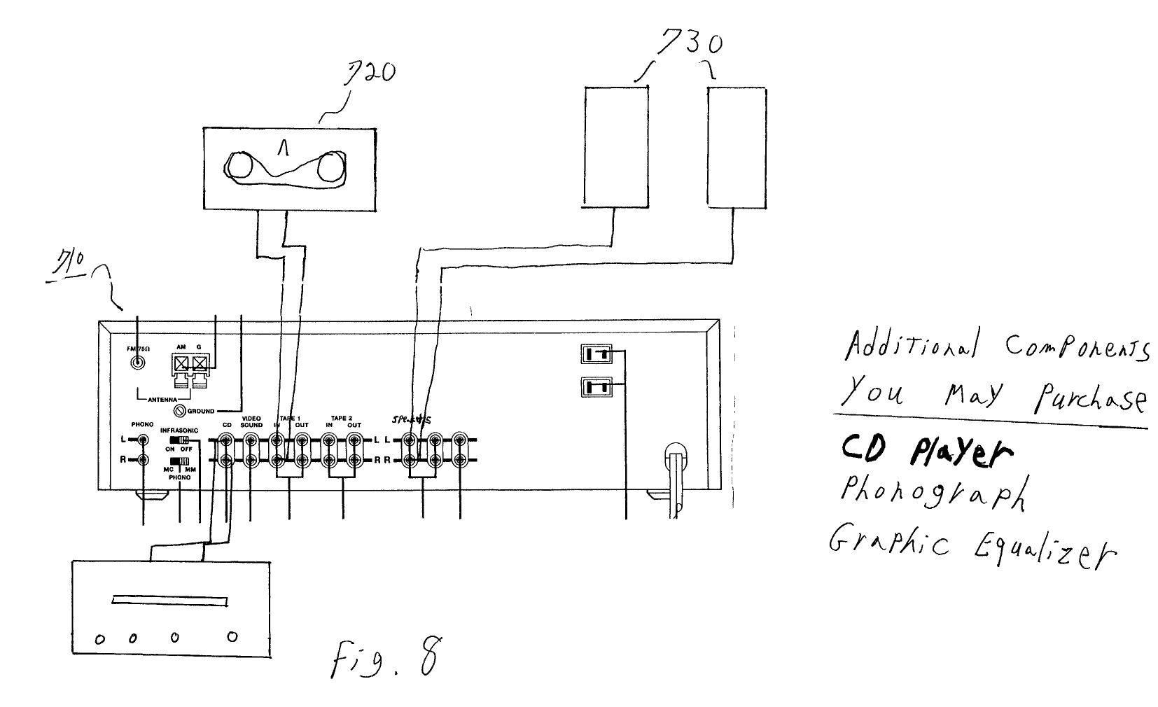

The present invention will be further illustrated by way of an example. For instance, the product being registered by the customer may be a stereo receiver. Accordingly, after the registration form has been submitted and processed, central processor 205 retrieves the product information pertaining to the particular stereo receiver specified by the customer. As shown in FIG. 7, the customer is presented with a visual representation of the stereo receiver 710. The illustration also includes a wiring diagram showing a visual representation of any other components that the customer has specified as being interconnected to the stereo receiver. For example, in FIG. 7, a tape player 720 and speakers 730 are shown connected to the stereo receiver 710. Moreover, the tape player and speakers are shown being connected to the appropriate inputs of the receiver 710. The customer is further presented with a list of additional components that can be connected to any of the unused inputs of the stereo receiver. In this example a compact disk player, a phonograph, and a signal processor such as a graphic equalizer are listed as optional components. The additional components function as selectable icons. If the customer is interested in obtaining more information, he or she simply selects the component of interest. As shown in FIG. 8, a visual representation of the selected component appears on the display of the customer's interface device, properly interconnected to the stereo receiver. In some embodiments of the invention, a detailed product description of the selected component also appears on the display. By allowing the customer to easily visualize how the additional components will interconnect with, and facilitate their use and enjoyment of, the product being registered, the merchant increases the likelihood that the customer will purchase the product being registered. This may be particularly true for products the customer initially may be unfamiliar with such as a signal processor.

The additional products to be offered to the customer need not be determined strictly by the product being registered. In the previous example, if the customer indicates that he or she has a particular brand of pair of speakers, for instance, the customer may be offered the option of purchasing a subwoofer designed to accompany those particular speakers.

One important advantage accruing from the present invention is that the customer can be provided with a well targeted, customized list of items that he or she may be particularly interested in. For example, if the stereo receiver being registered is an expensive, high-end unit typically purchased by discerning audiophiles, then presumably the customer will be interested in additional items of equal quality. Accordingly, the additional components being offered to the customer should all be equally high-end units, or least the closest available from the merchant. In this way the customer does not have to view the many lower-end units which are not likely to be of interest.

Another important advantage accruing from the present invention is that the merchant is able to get the customer's attention when he or she is often inclined to make an investment in product enhancements or additional products that can enhance the use and enjoyment of the initially purchased product. This behavior may result from the customer's initial excitement and enthusiasm for the purchase.

Continuing with reference to FIG. 5, if the customer decides to purchase an item or items, he or she can select an icon that may be included with the product information for that item or items, which has already been retrieved. The icon allows the selected item to be added to a customer “shopping-cart.” The shopping-cart is a customer-specific data structure that is generated and maintained in shopping cart database 265 of merchant web server 130. The information contained in shopping cart database 265 includes a list of products that have been selected by the customer for prospective purchase. In one embodiment of the invention, the shopping cart remains available to the customer for an extended period of time, e.g., one month, following the most recent access by the customer, allowing the customer to discontinue and later resume a session without loss of data. In this way the customer can effectively conduct an extended shopping session that begins with the registration process.

1. A method of performing on-line registration over an open computer network of an item previously purchased by a customer, said method comprising the steps of:
receiving over the open computer network a request from the customer to register the purchased item;
providing over the open computer network a registration form to be completed by the customer, said registration form requesting customer information including an identifier identifying the purchased item;
upon receiving a completed registration form from the customer, searching a database to generate a list of purchasable items, said list of purchasable items being selected based at least in part on the identifier which identifies the purchased item; and
providing the customer with the list of purchasable items and an opportunity to purchase any one or more of the purchasable items.

2. The method of claim 1 wherein said open computer network is the Internet.

3. The method of claim 1 wherein said customer information requested by the registration form further includes a customer name, physical address, electronic mail address and a phone number.

4. The method of claim 1 wherein said customer information requested by the registration form further includes a list of one or more items in possession of the customer having functionality associated with the purchased item.

5. The method of claim 1 wherein said registration form includes a pull-down menu that includes a list of one or more items having functionality associated with the purchased item.

6. The method of claim 1 further comprising the steps of assigning a unique identification number to the customer and creating a database entry for the customer that includes the customer information.

7. The method of claim 1 wherein the list of purchasable items includes a description of features and specifications for each purchasable item.

8. The method of claim 1 wherein said purchasable items include an upgrade or enhancement to the purchased item.

9. The method of claim 1 wherein said purchasable items include items that are usable in conjunction with the purchased item.

10. The method of claim 4 wherein said purchasable items include items that are usable in conjunction with said one or more items in possession of the customer having functionality associated with the purchased item.

11. The method of claim 1 wherein said purchased item includes audio-visual equipment.

12. The method of claim 1 wherein the step of providing the customer with the list of purchasable items includes providing the customer with a selectable icon that represents each of the purchasable items.

13. The method of claim 12 wherein, upon selection of a selectable icon by the customer, further providing a visual representation of the selected purchasable item corresponding to the selected icon.

14. The method of claim 13 wherein said visual representation of the selected purchasable item includes a diagram depicting the interoperability between the purchased item and the selected purchasable item.

15. The method of claim 14 wherein said diagram includes a wiring diagram.

16. The method of claim 4 further providing a visual representation of said one or more items in possession of the customer having functionality associated with the purchased item.

17. The method of claim 16 wherein said visual representation of said one or more items in possession of the customer includes a diagram depicting the interoperability between the purchased item and said one or more items in possession of the customer.

18. The method of claim 14 wherein said diagram includes a wiring diagram.

19. The method of claim 4 wherein said list of purchasable items is additionally based on said list of one or more items in possession of the customer having functionality associated with the purchased item.

20. The method of claim 1 further comprising the step of receiving a purchase request from the customer to purchase any one or more of the purchasable items.

21. The method of claim 1 wherein the step of providing the customer with the opportunity to purchase any one or more of the purchasable items includes the step of providing a selectable icon linked to a shopping cart database.

22. The method of claim 4 wherein said one or more items in possession of the customer having functionality associated with the purchased item includes one or more items interconnected to the purchased item.

23. The method of claim 1 wherein said previously purchased item is a service.

24. The method of claim 1 wherein said previously purchased item includes a service component.

25. The method of claim 1 wherein the step of providing the customer with the list of purchasable items includes the step of providing the list over the open computer network.

26. The method of claim 25 wherein the step of providing an opportunity to purchase any one or more of the purchasable items includes the step of providing the opportunity to complete the purchase over the open computer network.

27. An apparatus for performing on-line registration over an open computer network of an item previously purchased by a customer, comprising:
a controller unit for receiving over the open computer network a request from the customer to register the purchased item;
means for providing over the open computer network a registration form to be completed by the customer, said registration form requesting customer information including an identifier identifying the purchased item;
means for searching a database to generate a list of purchasable items upon receiving a completed registration form from the customer, said list of purchasable items being selected based at least in part on the identifier which identifies the purchased item; and
means for providing the customer with the list of purchasable items and an opportunity to purchase any one or more of the purchasable items.

28. The apparatus of claim 27 wherein said open computer network is the Internet.

29. The apparatus of claim 27 wherein said customer information requested by the registration form further includes a customer name, physical address, electronic mail address and a phone number.

30. The apparatus of claim 27 wherein said customer information requested by the registration form further includes a list of one or more items in possession of the customer having functionality associated with the purchased item.

31. The apparatus of claim 27 wherein said registration form includes a pull-down menu that includes a list of one or more items having functionality associated with the purchased item.

32. The apparatus of claim 27 wherein said controller assigns a unique identification number to the customer and further comprising a database having a database entry for the customer that includes the customer information.

33. The apparatus of claim 27 wherein the list of purchasable items includes a description of features and specifications for each purchasable item.

34. The apparatus of claim 27 wherein said purchasable items include an upgrade or enhancement to the purchased item.

35. The apparatus of claim 27 wherein said purchasable items include items that are usable in conjunction with the purchased item.

36. The apparatus of claim 30 wherein said purchasable items include items that are usable in conjunction with said one or more items in possession of the customer having functionality associated with the purchased item.

37. The apparatus of claim 36 wherein said means for providing the customer with the list of purchasable items includes means for providing the customer with a selectable icon that represents each of the purchasable items.

38. The apparatus of claim 37 further comprising means for providing a visual representation of a selected purchasable item corresponding to a selected icon.

39. The apparatus of claim 38 wherein said visual representation of the selected purchasable item includes a diagram depicting the interoperability between the purchased item and the selected purchasable item.

40. The apparatus of claim 30 further comprising means for providing a visual representation of said one or more items in possession of the customer having functionality associated with the purchased item.

41. The apparatus of claim 16 wherein said visual representation of said one or more items in possession of the customer includes a diagram depicting the interoperability between the purchased item and said one or more items in possession of the customer.

42. The apparatus of claim 27 further comprising means for receiving a purchase request from the customer to purchase any one or more of the purchasable items.
